(19) United States
(12) Patent Application Publication
(10) Pub. No.: US 2010/0104251 A1
(43) Pub. Date: Apr. 29, 2010

(54) OPTICAL WAVEGUIDE AND MANUFACTURING METHOD THEREOF

(75) Inventors: Masayuki Hodono, Ibaraki-shi (JP); Naoyuki Matsuo, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 12/574,314

(22) Filed: Oct. 6, 2009

Related U.S. Application Data
(60) Provisional application No. 61/114,245, filed on Nov. 13, 2008.

(30) Foreign Application Priority Data
Oct. 23, 2008 (JP) 2008-273223

(51) Int. Cl. G02B 6/10; B29D 11/00

(52) U.S. Cl. 385/129; 264/1.37

(57) ABSTRACT

An optical waveguide having a light path deflecting capability, including a core layer defining a light path, two cladding layers holding the core layer therebetween and covering the core layer, and a light path deflection structure formed selectively in a predetermined region of the core layer having a light path deflection cavities arranged at predetermined intervals in a matrix array in a phantom plane inclined at a predetermined angle with respect to an optical axis of the core layer by applying a laser beam a plurality of times to the core layer through either of the cladding layers without damaging the cladding layers. A method for manufacturing an optical waveguide having a light path deflecting capability including applying a laser beam a plurality of times to the core layer through either of the cladding layers without damaging the cladding layers and without damaging an outer surface of the optical waveguide.

### RELATED APPLICATIONS

This application claims the benefit of U.S. Provisional Application No. 61/114,245, filed Nov. 13, 2008, which is hereby incorporated by reference.

### BACKGROUND OF THE INVENTION

1. Field of the Invention

The present invention relates to an optical waveguide having a light path deflection mechanism provided on a light path of light passing through a core, and a manufacturing method thereof.

2. Description of the Related Art

Optical waveguides are incorporated in optical devices such as optical waveguide devices, optical integrated circuits and optical wiring boards, and widely used in the field of optical communications, optical information processing and other general optics. Such an optical device is often adapted to deflect a light path at 90 degrees at an end portion or other predetermined portion of an optical waveguide, for example, to transmit an optical signal from alight emitting element to a light receiving element via the optical waveguide.

That is, as shown in FIG. 3, the optical waveguide has surfaces (micro mirrors) M, M′ provided at an end portion or other predetermined portion thereof with respect to the optical axis (light path) L (an x-direction in FIG. 3) as being inclined at 45 degrees with respect to the optical axis thereof. Thus, the inclined surfaces M, M′ reflect the optical signal from the light emitting element or the like to deflect the light path at 90 degrees. In FIG. 3, reference numerals 1, 2, 2′ and B denote a core layer, a first cladding (under-cladding) layer, a second cladding (over-cladding) layer, and a cutting blade, respectively. The optical waveguide having the light path deflection mechanism may be employed as a light converting element for an opto-electric hybrid board.

Exemplary methods for forming the inclined surfaces (micro mirrors) in the optical waveguide include a method such that apart or an end portion of the optical waveguide is cut at 45 degrees by means of a diamond dicing blade, a method employing a laser for the cutting, and a method employing reactive ion etching for the formation (see, for example, JP-A-HEI10(1998)-300961, JP-A-2005-25019 and JP-A-2006-251219).

Particularly, a method (a dicing blade method, see FIG. 3) such that a thin diamond blade B having an angled blade edge is rotated to perpendicularly cut into the optical waveguide is widely employed, because this method permits easy formation of highly smooth mirror surfaces (mirrors) by properly selecting the blade B (see, for example, JP-A-2006-201372 and JP-A-2007-108228).

### DISCLOSURE OF THE INVENTION

However, the aforementioned dicing blade method for forming the light deflection micro mirrors M, M′ employs a disk blade B having a sufficiently greater size (diameter) than the light path for the processing. Therefore, where a plurality of optical waveguides are arranged parallel to each other in adjacent relation, optical waveguides adjacent to the optical waveguide to be processed are also cut, making it impossible to form the micro mirrors M, M′ at different longitudinal positions in the optical waveguides.

Since a V-shaped groove is formed by cutting (or severing), cracks are liable to develop from the cut portion (micro mirror portion) and grow due to a shock and thermal expansion/contraction. There is a possibility that, in the worst case, cracking or fracture occur throughout the optical waveguides, thereby damaging a circuit board incorporating the optical waveguides.

In view of the foregoing, it is an object of the present invention to provide a highly reliable optical waveguide which is unlikely to be influenced by a shock and thermal expansion/contraction, and has a stable light path deflecting capability for a long period of time, and to provide an optical waveguide manufacturing method which permits efficient production of the highly reliable optical waveguide by forming a light path deflection structure at a desired position in a core layer provided inside the optical waveguide without damaging an outer surface of the optical waveguide.

According to a first aspect of the present invention to achieve the aforesaid object, there is provided an optical waveguide, which includes a core layer defining a light path, and two cladding layers holding the core layer therebetween as covering the core layer, wherein the core layer has a plurality of light path deflection cavities formed selectively in a predetermined region thereof being arranged at predetermined intervals in a matrix array in a phantom plane inclined at a predetermined angle with respect to an optical axis of the core layer by applying a laser beam a plurality of times to the core layer through either of the cladding layers.

According to a second aspect of the present invention, there is provided an optical waveguide manufacturing method of manufacturing an optical waveguide including a core layer defining a light path, and two cladding layers holding the core layer therebetween covering the core layer, the core layer having a light path deflection structure provided in a predetermined region thereof for reflecting light incident thereon at a predetermined angle, the method including the steps of: placing a workpiece including the core layer and the cladding layers on a stage; forming a discrete cavity in a desired portion of the core layer by applying a single pulse of a laser beam emitted from a pulse laser and focused at a predetermined depth to the core layer; moving the stage and a focus of the laser beam relative to each other by a predetermined distance in a predetermined direction; and repeating the cavity formation step and the relative movement step to form a multiplicity of discrete cavities arranged at predetermined intervals in a matrix array in a phantom plane inclined at the predetermined angle with respect to an optical axis of the core layer to form the light path deflection structure selectively in the predetermined region of the core layer without damaging the cladding layers.

The inventors of the present invention conducted intensive studies to solve the aforementioned problems and, as a result, found that minute discrete cavities can be formed regularly arranged in a matrix array in the inner core layer without damaging the cladding layers covering the core layer by employing a pulse laser capable of emitting an ultra-short pulse beam of picosecond (ps) or femtosecond (fs) duration, and light passing through the core layer can be efficiently reflected by the matrix array of cavities. Thus, the present invention was attained.

As described above, the inventive optical waveguide includes the plurality of cavities which are formed in the predetermined region of the core layer arranged at the predetermined intervals in the matrix array in the phantom plane inclined at the predetermined angle with respect to the optical axis of the core layer by a laser beam applied through the cladding layer. The matrix array of cavities functions as if it were a micro mirror formed in the phantom plane, and is capable of deflecting the light path of the light (or reflecting the light) passing through the core layer. Unlike the micro mirror formed by the prior-art dicing blade method, the light path deflection structure provided in the form of the cavities is free from positional limitation, and does not have a notch from which cracks are liable to develop and grow. Further, the optical waveguide is free from any damage on outer surfaces of the cladding layers, and the cavities are stably maintained without exposure to the atmosphere. Therefore, the inventive optical waveguide is unlikely to be influenced by an external shock, temperature fluctuation, dirt and dust, and hence has a stable light path deflecting capability for a long period of time.

The cavities preferably each have a diameter of 5 to 20 μm and are arranged at intervals of 1 to 20 μm without communication therebetween. In this case, the light path of the light passing through the core layer can be efficiently deflected (the light can be efficiently reflected).

A light source for the laser beam is preferably a picosecond pulse laser or a femtosecond pulse laser having a pulse width of not greater than 5000 ps. The pulse laser is capable of efficiently forming the cavities selectively in the core layer.

In the inventive optical waveguide manufacturing method, the workpiece including the core layer and the cladding layers is placed on the stage, and the discrete cavity is formed in the desired portion of the core layer by applying the laser beam emitted from the pulse laser and focused at the predetermined depth to the core layer. Then, the stage and the focus of the laser beam are moved relative to each other by a predetermined distance in a predetermined direction. Further, the cavity formation step and the relative movement step are repeated, whereby the light path deflection structure is formed having a multiplicity of cavities arranged at the predetermined intervals in the matrix array in the phantom plane inclined at the predetermined angle with respect to the optical axis of the core layer in the predetermined region of the core layer.

Therefore, even if a plurality of optical waveguides are arranged parallel to each other in adjacent relation, the light path deflection structure can be formed at any desired longitudinal position in each light path without influencing adjacent optical waveguides not intended to be processed. The manufacturing method described above does not damage the outer surfaces of the cladding layers, and the resulting cavities are not exposed to the atmosphere. Unlike the dicing blade method, the inventive manufacturing method is free from development and growth of cracks. This eliminates the possibility that the resulting optical waveguide is cracked or fractured, or a circuit board or the like provided with the optical waveguide is damaged. Therefore, the inventive optical waveguide manufacturing method is capable of manufacturing a highly reliable optical waveguide having a longer service life.

The inventive optical waveguide manufacturing method facilitates maintenance of a manufacturing apparatus without a need for replacement of a grinding stone or the like. Further, the inventive method is substantially free from uncertainty factors because of noncontact processing, and requires a shorter processing cycle time (interval). Therefore, the inventive optical waveguide manufacturing method is capable of efficiently producing the optical waveguide having the aforementioned light path deflection structure with an improved product yield.

The laser beam emitted from the pulse laser preferably has a wavelength of 300 to 2500 nm, a pulse width of not greater than 5000 ps, a pulse energy of 100 nJ/pulse to 1 mJ/pulse, and a fluence of 0.01 to 1 J/cm². In this case, the cavities can be efficiently formed by a single pulse as having a diameter of 5 to 20 μm and an interval of 1 to 20 μm.

In the present invention, the core layer covered with the cladding layers is selectively processed by the laser beam emitted through the cladding layer. Therefore, an ultra-short pulse laser such as a femtosecond fs (10⁻¹⁵) laser or a picosecond ps (10⁻¹²) laser which is likely to experience a multiphoton absorption process is preferably used as the pulse laser.

The laser to be used preferably has a wavelength of 300 to 2500 nm at which light is less liable to be absorbed by the cladding layers. At the wavelength of this range, the cladding layers are unlikely to be processed (damaged) by single photon absorption.

The laser to be used desirably has a pulse width of not greater than 5000 ps (picoseconds), preferably not greater than 1000 ps, more preferably not greater than 100 ps, which is likely to experience the multiphoton absorption process. The pulse width has no lower limit.

The pulse energy and the fluence of the laser to be used are optimized according to the physical properties of a material for the core layer. The pulse energy is preferably in the range of 100 nJ to 1 mJ per pulse. If the pulse energy is less than 100 nJ/pulse, it is difficult to properly process the core layer. If the pulse energy is greater than 1 mJ/pulse, conversely, ablation is liable to occur, making it difficult to form the cavities at a higher level of accuracy.

Similarly, the fluence of the laser is preferably in the range of 0.01 to 1 J/cm². If the fluence is less than 0.01 J/cm², it is difficult to properly process the core layer. If the fluence is greater than 1 J/cm², ablation is liable to occur, making it difficult to form the cavities at a higher level of accuracy.

### BRIEF DESCRIPTION OF THE DRAWINGS

FIGS. 1A and 1B are schematic diagrams illustrating a light path deflection structure of an optical waveguide according to an embodiment of the present invention.

FIG. 2 is a schematic diagram showing the construction of an apparatus for forming the light path deflection structure in the optical waveguide according to the embodiment of the present invention.

FIG. 3 is a schematic diagram showing a prior-art method for forming a light path deflection structure (micro mirror) in an optical waveguide.

### DETAILED DESCRIPTION OF THE INVENTION

Next, embodiments of the present invention will be described in detail with reference to the drawings.

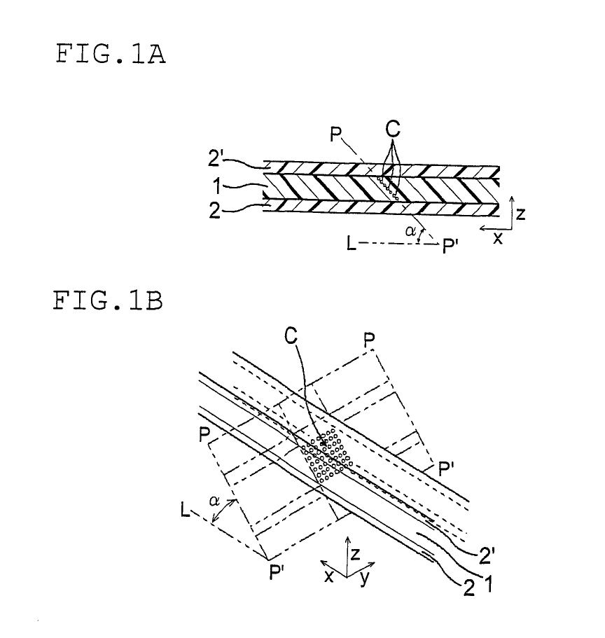

FIGS. 1A and 1B are schematic diagrams for explaining the construction of an optical waveguide according to an embodiment of the present invention. For explanation, it is herein assumed that a longitudinal direction of the optical waveguide extending along a light path of light inputted from an end portion (not shown) of a core layer 1 (an optical axis L) is an x-direction, a transverse direction of the optical waveguide perpendicular to the optical axis L is a y-direction, and a thickness direction of the optical waveguide perpendicular to the optical axis L is a z-direction. The core layer and cladding layers of the optical waveguide are illustrated as each having a greater thickness for emphasis.

The optical waveguide according to this embodiment has substantially the same basic construction as the prior-art optical waveguide, and includes a core layer 1 defining a light path, and two cladding layers 2, 2′ holding the core layer 1 from upper and lower sides (with respect to the z-direction in FIG. 1) and covering the core layer 1. The core layer 1 of the optical waveguide includes a multiplicity of light path deflection cavities C, C, . . . which are formed selectively in a partial region thereof by applying a laser beam a plurality of times to the core layer 1 through either of the cladding layers 2, 2′ (by means of a pulse laser).

The cavities C, C, . . . each have a diameter of 5 to 20 μm, and are arranged at intervals of 1 to 20 μm. These cavities are arranged in a matrix array in a phantom plane P-P′ inclined at an angle α (45 degrees in this embodiment) with respect to the optical axis L of the core layer 1.

When an optical signal is inputted, for example, from a light emitting element or the like on one side of the optical axis L of the core layer 1, light passing through the core layer 1 is reflected at the angle α by the discrete cavities C arranged in the matrix array in the phantom plane P-P′. Therefore, the phantom plane P-P′ in which the cavities C are arranged serves as a single micro mirror to deflect the light path (light axis).

In this embodiment, the cavities C are formed selectively only in the region of the core layer 1 without damaging the cladding layers 2, 2′, so that the cavities C are stably maintained without exposure to the atmosphere. Therefore, the light path deflection structure of the optical waveguide according to this embodiment is unlikely to be influenced by an external shock, temperature fluctuation, dirt and dust, and hence has a stable light path deflecting capability for a long period of time.

The optical waveguide to be used in this embodiment is preferably a polymer-based optical waveguide which can be easily processed by the pulse laser. Examples of a material for the cladding layers 2, 2′ include epoxy resins, polyimide resins, acryl resins, photopolymerizable resins and photosensitive resins, among which the epoxy resins are preferred and a resin mixture of a fluorene epoxy resin and an alicyclic epoxy resin is particularly preferred in terms of transparency, heat resistance and moisture resistance. Typical examples of a material for the core layer 1 include photopolymerizable resins such as containing any of epoxy resins, polyimide resins and acryl resins, among which a resin mixture of a fluorene epoxy resin and an oxetane compound is preferred.

Next, an apparatus and a method for manufacturing the optical waveguide will be described.

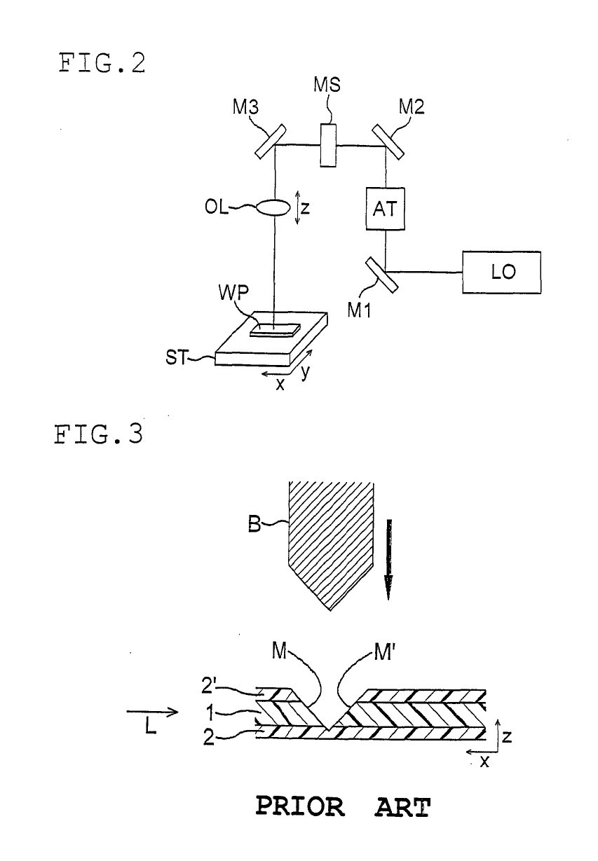

FIG. 2 is a schematic diagram of an apparatus for forming the light path deflection structure including the cavities C in the core layer 1 according to this embodiment. In FIG. 2, reference characters LO, AT, MS, OL, ST and WP denote a laser oscillator, an attenuator (output controlling device), a mechanical shutter, an object lens, an XY-stage and a workpiece (to be processed), respectively, and reference characters M1 to M3 denote total reflection mirrors.

The stage ST is a precisely position-controllable stage (processing base) which is movable independently in two directions in an xy-plane. A laser processing apparatus to be employed is capable of adjusting its focal distance for the laser beam with respect to the workpiece WP on the stage ST by vertically moving the light converging object lens OL in the z-direction.

The relative movement of the workpiece WP and the focus of the laser beam (the positioning for the processing) is achieved by employing the precisely controllable stage ST (processing base) movable independently in the two directions in the xy-plane and a laser apparatus capable of changing an irradiation depth vertically (in the z-direction) in combination as described above. Alternatively, the relative movement may be achieved by employing a precisely controllable stage (processing base) movable independently in three directions (the x-, y- and z-directions) perpendicular to each other to move the workpiece or by fixing the workpiece and scanning a laser beam by a laser apparatus having a galvano-scanner (galvano-mirror).

In the step of forming the light path deflection structure including the cavities C in the core layer 1, the workpiece WP including the core layer 1 and the cladding layers 2, 2′ is placed on the stage ST with one of the cladding layers (in this case, a second cladding layer 2′) facing up, and fixed to the stage ST by a fixture.

The convergent focus of the laser beam passing through the attenuator AT for output control, the mechanical shutter MS for irradiation pulse count control and the light converging object lens OL (having a magnification of 10×) is positioned at a predetermined portion of the core layer 1, and then the laser oscillator LO is oscillated to generate laser pulses, one of which is applied to the core layer 1, whereby one cavity is formed in the core layer 1. The laser pulses generated by the laser oscillator LO are picosecond pulses or femtosecond pulses each having a pulse width of 5000 ps.

After the formation of the one cavity, the stage ST is moved a predetermined distance in the y-direction shown in FIG. 2. The formation of a cavity by the application of a single pulse and the movement of the stage ST are repeated for the width of the core layer 1 (as measured in the y-direction) to form a row of cavities aligned in the y-direction (in this case, the uppermost row of cavities located closest to the cladding layer 2′).

Thereafter, the stage ST is moved a predetermined distance in the x-direction, and the convergent focus of the laser beam is moved a predetermined distance in the z-direction. Then, the formation of a cavity by the application of a single pulse and the movement of the stage ST in the Y-direction are repeated in the aforementioned manner to form another row of cavities aligned in the y-direction.

Thus, each row of cavities aligned in the y-direction is formed by slightly moving the stage in the x-direction and in the y-direction, whereby a matrix array of cavities arranged in a phantom plane P-P′ is finally formed selectively in a desired region of the core layer 1 as shown in FIG. 1B.

As described above, the optical waveguide manufacturing method is capable of forming the cavities C selectively only in the core layer 1 without damaging the cladding layers 2, 2′. Further, the cavities C are not exposed to the atmosphere and are free from the development and the growth of cracks which may otherwise occur in the case of the prior-art dicing blade method. This eliminates the possibility that the resulting optical waveguide is cracked or fractured, or a circuit board or the like provided with the optical waveguide is damaged. Therefore, the optical waveguide manufacturing method according to this embodiment is capable of manufacturing a highly reliable optical waveguide having a longer service life.

Unlike the prior-art dicing blade method, the optical waveguide manufacturing method described above facilitates the maintenance of the manufacturing apparatus without a need for replacement of a grinding stone. Further, the optical waveguide manufacturing method is substantially free from uncertainty factors because of noncontact processing, and requires a shorter processing cycle time (interval). Therefore, the optical waveguide manufacturing method according to this embodiment is capable of efficiently producing the optical waveguide having the aforementioned light path deflection structure.

In this embodiment, the light path deflection structure is formed in the core layer 1 of the optical waveguide as being inclined at 45 degrees with respect to the optical axis L by way of example, but the inclination angle α of the phantom plane P-P′ with respect to the optical axis L is not particularly limited. For example, the inclination angle α may be any angle within the range of 10 to 80 degrees.

Even if a plurality of optical waveguides are arranged parallel to each other in adjacent relation, the optical waveguide manufacturing method according to this embodiment permits formation of a light path deflection structure at any desired longitudinal position in each light path without influencing adjacent optical waveguides not intended to be processed.

Next, an inventive example will be described. However, the invention is not limited to the example.

### Example

### Production of Optical Waveguide Film

An optical waveguide film to be processed through irradiation with a laser beam was first produced in the following manner.

### Under-Cladding Layer Material and Over-Cladding Layer Material

Component (A): 35 parts by weight of bisphenoxyethanolfluorene diglycidyl ether
Component (B): 40 parts by weight of 3′,4′-epoxycyclohexyl methyl-3,4-epoxycyclohexanecarboxylate (an alicyclic epoxy resin CELLOXIDE 2021P manufactured by Daicel Chemical Industries, Ltd.)
Component (C): 25 parts by weight of (3′,4′-epoxycyclohexane)methyl-3′,4′-epoxycyclohexyl carboxylate (CELLOXIDE 2081 manufactured by Daicel Chemical Industries, Ltd.)
Component (D): 1 part by weight of a 50% propione carbonate solution of 4,4′-bis[di(β-hydroxyethoxy)phenylsulfinio]phenylsulfide bishexafluoroantimonate (photoacid generator)

Components (A), (B), (C) and (D) were mixed together, whereby a material for an under-cladding (first cladding) layer and an over-cladding (second cladding) layer was prepared.

### Core Layer Material

Component (A): 70 parts by weight of bisphenoxyethanolfluorene diglycidyl ether
Component (E): 30 parts by weight of 1,3,3-tris{4-[2-(3-oxetanyl)]butoxyphenyl}butane
Component (D): 0.5 parts by weight of a 50% propione carbonate solution of 4,4′-bis[di(β-hydroxyethoxy)phenylsulfinio]phenylsulfide bishexafluoroantimonate (photoacid generator)

Components (A), (E) and (D) were dissolved in 28 parts by weight of ethyl lactate, whereby a material for core layers was prepared.

### Formation of Under-Cladding Layer

A PET film was bonded to a glass plate by a double-sided adhesive tape, and the cladding layer material was applied onto the PET film by a spin coating method to form a 25-μm thick coating layer. Then, the coating layer was entirely irradiated with ultraviolet radiation (i-line at a cumulative dose of 1000 mJ/cm² as measured at 365 nm) by means of an ultra-high-pressure mercury-vapor lamp. Thus, the coating layer was cured to provide the under-cladding layer.

### Formation of Core Layers

The core layer material was applied onto an upper surface of the under-cladding layer by a spin coating method, and heated on an 80° C. hot plate to evaporate a solvent. Thus, a resin layer for the core layers was formed. The thickness of the resin layer for the core layers was adjusted to 50 μm as measured after the evaporation of the solvent. In turn, the resin layer was exposed by irradiation with ultraviolet radiation (i-line at a cumulative dose of 2000 mJ/cm² as measured at 365 nm) via a photomask having a predetermined opening pattern (including openings each having an opening width of 50 μm and spaced a distance of 200 μm from each other) by means of an ultra-high-pressure mercury-vapor lamp. Subsequently, the resulting resin layer was heated on a 120° C. hot plate for 15 minutes for completion of a reaction. Then, a development process was performed by using a 10 wt % γ-butyrolactone aqueous solution to dissolve away unexposed portions, and a heat drying treatment was performed at 120° C. for 15 minutes. Thus, the core layers (each having a thickness of 50 μm) were formed on the under-cladding layer.

### Formation of Over-Cladding Layer

In turn, the cladding layer material was applied over the core layers on the under-cladding layer as covering the core layers by a spin coating method. Thus, a coating layer having a thickness of about 25 μm for the over-cladding layer was formed. The thickness of the coating layer for the over-cladding layer was adjusted so that the optical waveguide film excluding the PET film had an overall thickness of 100 μm. Further, grooves (unexposed portions) defined between the core layers were filled with the cladding layer material. Thereafter, the coating layer was entirely irradiated with ultraviolet radiation (i-line at a cumulative dose of 1000 mJ/cm² as measured at 365 nm) by means of an ultra-high-pressure mercury-vapor lamp as in the formation of the under-cladding layer. Thus, the coating layer was cured to provide an optical waveguide film (having an overall thickness of 100 μm) in which the core layer was held between the two cladding layers as covered with the cladding layers. In the following laser processing experiment, the PET film was separated from the optical waveguide film.

### Laser Processing Apparatus

A femtosecond (10⁻¹⁵) fs pulse laser (available from Cyber Laser Inc., and having a maximum average output of 0.5 W and a repetitive frequency of 1 kHz) was used as a laser oscillator.

### Laser Pulse

A laser beam was adjusted so as to have a wavelength of 800 nm, a pulse width of 150 fs, a pulse energy of 1.5 μJ/pulse (an output of 0.0015 W).

The apparatus had the same overall construction as in the embodiment described above (FIG. 2). The convergent focus of the laser beam passing through the output control attenuator AT, the irradiation pulse count control mechanical shutter MS and the light convergent object lens OL (with a magnification of 10×) along alight path deflected by the total reflection mirrors M1 to M3 was controlled to be located at a predetermined portion of a core layer of the optical waveguide film.

The stage ST on which the workpiece (to be processed) was fixed was a stage (processing base) which was position-controllable on the order of micrometer independently in the two directions in the xy-plane. The focal distance of the laser was changed (in the z-direction) by controlling the height of the light convergent object lens OL with respect to the object.

### Formation of Light Path Deflection Cavities

The workpiece WP including the core layer and the cladding layers was placed on the stage ST with one of its cladding layers (the over-cladding layer in this case) facing up, and fixed to the stage ST by the fixture.

In turn, the properly conditioned laser oscillator LO was oscillated to generate laser pulses, one of which was applied to a predetermined portion of the core layer to form a single cavity (having an average diameter of 10 μm). After the formation of the single cavity, the stage ST was moved 5 μm in the y-direction. The formation of the cavity by the application of the single pulse and the movement of the stage ST were repeated for the width of the core layer (50 μm as measured in the y-direction) to form a row of cavities aligned in the y-direction (the uppermost row of cavities located closest to the over-cladding layer).

After the stage ST was moved 5 μm in the x-direction and the convergent focus of the laser beam was moved 5 μm in the z-direction, the formation of the cavity by the application of the single laser pulse and the movement (5 μm) of the stage ST in the y-direction were repeated to form another row of cavities aligned in the y-direction.

Thus, each row of cavities aligned in the y-direction is formed by slightly moving the stage in the x-direction and in the y-direction, whereby a matrix array of cavities C arranged in a phantom plane inclined at 45 degrees with respect to the optical axis L as shown in FIG. 1B was formed as the light path deflection structure selectively in a desired portion of the core layer of the optical waveguide film without damaging the cladding layers.

Next, a performance test was performed on the resulting optical waveguide film in the following manner.

Light (emitted at 850 nm from a VCSEL light source) was applied to the light path deflection structure including the array of cavities C from the above perpendicularly to the over-cladding layer (in the z-direction) in the optical waveguide film produced in the aforementioned example. Light deflected at 90 degrees by the light path deflection structure and traveling along the core layer to an end of the optical waveguide was detected by a light receiving element, and a coupling loss was determined. The VCSEL (vertical cavity surface emitting laser) light source (available from Ulm Photonics GmbH) was employed as a light emitting element, and the light was emitted via a multimode fiber. A photo detector PD (available from Roithner Laser Technik GmbH) was employed as the light receiving element.

Further, the light amount I₀ of the light emitting element and the light amount I outputted from the end of the optical waveguide after the 90-degree light path deflection were measured by the PD, and the coupling loss (dB) was calculated based on the light amounts I₀, I and a propagation loss of the optical waveguide core (0.15 dB/cm) to be subtracted.

As a result, the coupling loss due to the 90-degree light path deflection was about 2.0 dB. It was found that the light path deflection structure had a practically sufficient light path deflecting capability as compared with a 45-degree micro mirror (having a coupling loss of 0.8 dB) formed by the prior-art dicing blade method. Through optical observation with a microscope or the like, it was confirmed that the cavities C were formed selectively only in the core layer without damaging the inner portions and the outer surfaces of the cladding layers of the resulting optical waveguide (film) or causing any other inconvenience.

Although a specific form of embodiment of the instant invention has been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention which is to be determined by the following claims.

What is claimed is:

1. An optical waveguide comprising:
a core layer defining a light path; and
two cladding layers holding the core layer therebetween covering the core layer;
wherein the core layer has a plurality of light path deflection cavities formed selectively in a predetermined region thereof arranged at predetermined intervals in a matrix array in a phantom plane inclined at a predetermined angle with respect to an optical axis of the core layer by applying a laser beam a plurality of times to the core layer through either of the cladding layers.

2. An optical waveguide as set forth in claim 1, wherein the cavities each have a diameter of 5 to 20 μm and are arranged at intervals of 1 to 20 μm without communication therebetween.

3. An optical waveguide as set forth in claim 1, wherein a light source for the laser beam is a picosecond pulse laser or a femtosecond pulse laser having a pulse width of not greater than 5000 ps.

4. An optical waveguide as set forth in claim 2, wherein a light source for the laser beam is a picosecond pulse laser or a femtosecond pulse laser having a pulse width of not greater than 5000 ps.

5. An optical waveguide manufacturing method of manufacturing an optical waveguide including a core layer defining a light path, and two cladding layers holding the core layer therebetween covering the core layer, the core layer having a light path deflection structure provided in a predetermined region thereof for reflecting light incident thereon at a predetermined angle, the method including the steps of:
placing a workpiece including the core layer and the cladding layers on a stage;
forming a discrete cavity in a desired portion of the core layer by applying a single pulse of a laser beam emitted from a pulse laser and focused at a predetermined depth to the core layer;
moving the stage and a focus of the laser beam relative to each other by a predetermined distance in a predetermined direction; and
repeating the cavity formation step and the relative movement step to form a multiplicity of discrete cavities arranged at predetermined intervals in a matrix array in a phantom plane inclined at the predetermined angle with respect to an optical axis of the core layer to form the light path deflection structure selectively in the predetermined region of the core layer without damaging the cladding layers.

6. An optical waveguide manufacturing method as set forth in claim 5, wherein the laser beam emitted from the pulse laser has a wavelength of 300 to 2500 nm, a pulse width of not greater than 5000 ps, a pulse energy of 100 nJ/pulse to 1 mJ/pulse, and a fluence of 0.01 to 1 J/cm².
